(19) United States
(12) Patent Application Publication
(10) Pub. No.: US 2013/0323695 A1
(43) Pub. Date: Dec. 5, 2013

(54) SIMULATOR FOR SKILL-ORIENTED TRAINING

(71) Applicants: David Zboray, Trumbull, CT (US); Matthew Bennett, Milford, CT (US); Andy Lundell, New Britain, CT (US); Jeremiah Hennessey, East Walpole, MA (US); Zach Lenker, Vernon, CT (US); Matthew Wallace, South Windsor, CT (US); Jon Kallen, Norwich, CT (US); Rebecca McKnight, Vernon, CT (US)

(72) Inventors: David Zboray, Trumbull, CT (US); Matthew Bennett, Milford, CT (US); Andy Lundell, New Britain, CT (US); Jeremiah Hennessey, East Walpole, MA (US); Zach Lenker, Vernon, CT (US); Matthew Wallace, South Windsor, CT (US); Jon Kallen, Norwich, CT (US); Rebecca McKnight, Vernon, CT (US)

(21) Appl. No.: 13/576,844

(22) PCT Filed: Feb. 7, 2011
(86) PCT No.: PCT/US11/00220

§ 371 Date: Jun. 27, 2013

Related U.S. Application Data
(60) Provisional application No. 61/301,766, filed on Feb. 5, 2010.

(51) Int. Cl. G09B 19/00

(52) U.S. Cl. CPC G09B 19/00
USPC 434/219

(57) ABSTRACT

A simulator for skill-oriented training is presented. The simulator includes a platform having a platform sensor and provides a training environment depicting a work piece rendered on the platform. The simulator includes a display unit worn by a person operating the simulator. The unit includes a camera, a speaker and a unit sensor. The camera and the speaker provide visual and audio output to the person depicting the training environment. The simulator includes a controller and a data processing system. The controller is operated by the person and includes a controller sensor. The sensors cooperate to provide to the processing system signals representing spatial positioning, angular orientation and movement data of the controller relative to the platform. In response, the processing system renders the work piece, a virtual coating spray pattern, a virtual coating as applied to the work piece and performance guidance in the training environment.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND OF THE INVENTION

1. Technical Field

The present invention relates generally to a training system employing computer simulation and augmented virtual reality for instructing and evaluating the progress of a person performing a skilled-oriented task and, more particularly, to a simulator for instructing and evaluating performance of a skilled-oriented task of a process such as, for example, a component and/or assembly process performed by a tradesman.

2. Related Art

Generally speaking, training is needed for a person to acquire and/or maintain the skills necessary for performing a skill-oriented task such as, for example, constructing, assembling and/or finishing one or more components. For example, when performing a coating or spraying step, an operator must operate a spray coating system at an optimum distance and orientation from a subject surface to be painted or coated so that a coating is applied at a proper finish coat thickness on the surface. If, for example, a nozzle of the spray coating system is placed too close to the subject surface, an uneven wet film build-up may result and/or the coating may run or drip. Alternatively, if the nozzle is placed too far from the subject surface, overspraying or ineffective coverage results such that repeated passes are required to achieve the desired finish coat thickness. Repetition and correction of less than optimal practices is needed to ensure personnel acquire and/or maintain the necessary skills. However, repetition is time consuming and costly as raw materials (e.g., surfaces to be coated, coatings and preparation materials, etc.) are expensive. Moreover, some coatings raise environmental concerns during use and/or disposal, which again can negatively impact training costs. Accordingly, training time and costs need to be optimized.

There have been efforts to simulate spray coating operations to improve training and minimize costs. Some efforts have included the use of computer simulation and virtual reality. However, the inventors have discovered that these systems are expensive and lack the accuracy and “look and feel” of real life spray coating operations. As such, conventional simulation systems are of limited use within and benefit to the industry.

Accordingly, there is a need for improved training systems and method using computer simulation and augmented virtual reality and which permit evaluation of the progress of a person applying a coating using a spray coating system.

### SUMMARY OF THE INVENTION

The present invention is directed to a simulator for skill-oriented training of a task. The simulator includes a work piece platform having at least one platform sensor and an augmented, three-dimensional training environment depicting a work piece rendered on the work piece platform. The simulator also includes a head-mounted display unit (HMDU) worn by a person operating the simulator. The HMDU includes at least one camera, at least one speaker and at least one HMDU sensor. The camera and the speaker provide visual and audio output to the person thus depicting the training environment. The simulator also includes a controller operated by the person. The controller includes at least one controller sensor. The controller sensor, the HMDU sensor and the platform sensor cooperate to output one or more signals representing spatial positioning, angular orientation and movement data of the controller relative to the work piece platform. The simulator includes a data processing system coupled to the work piece platform, the HMDU, and the controller. The data processing system receives the one or more signals and executes a plurality of algorithms for rendering in real-time the work piece, a virtual coating spray pattern, a virtual coating as applied to the work piece and sensory guidance as to performance to the person in the training environment. The algorithms include a tracking engine, a physics engine and a rendering engine. The tracking engine receives the one or more signals from the controller sensor, the HMDU sensor and the platform sensor, and determines coordinates of a next position, next orientation, and a speed of movement of the controller in relation to the work piece and the work piece platform from a previous position and a previous orientation to the next position and the next orientation. The physics engine models a spray coating process and determines the virtual coating spray pattern and the applied virtual coating from the coordinates within the training environment. The rendering engine receives the modeled spray coat process and, in response thereto, renders the virtual coating spray pattern and the applied virtual coating in the training environment. The simulator operates such that the virtual coating spray pattern, the applied virtual coating and the sensory guidance are exhibited in near real-time to the operator within the training environment to provide in-process correction and reinforcement of preferred performance characteristics as the operator operates the controller.

In one embodiment, the sensory guidance exhibited to the operator include one or more of visual, audio and tactile indications of performance. In one embodiment, the applied virtual coating is depicted to include a plurality of coverage regions and the visual indications include one or more icons highlighting one or more of the plurality of coverage regions having less than optimal characteristics. In one embodiment, the one or more icons include a Too Close indication icon, a Too Far indication icon, a Bad Angle indication icon and a Too Fast indication icon.

In yet another embodiment, the audio indications of performance include an audio tone output by the at least one speaker of the HMDU. In one embodiment, the audio tone increases in volume or repeated pattern as the controller is positioned too close to the work piece. In one embodiment, the audio tone decreases in volume or repeated pattern as the controller is positioned too far from the work piece.

In yet another embodiment, the simulator includes a display device operatively coupled to the data processing system such that an instructor may monitor the performance of the person operating the controller.

In still another embodiment of the simulator, the controller further includes one or more haptic devices that impart at least one of forces, vibrations and motion to the person operating the controller.

### BRIEF DESCRIPTION OF THE DRAWINGS

Referring now to the Figures, which are exemplary embodiments, and wherein the like elements are numbered alike.

FIG. 1 is a schematic diagram of a coating simulator defining and operating within a three-dimensional spray coating environment, according to one embodiment of the present invention.

FIG. 2 depicts a head-mounted display unit, according to one embodiment of the present invention.

FIG. 3 is a simplified block diagram of components of the coating simulator of FIG. 1.

FIGS. 4-12 are exemplary graphical user interfaces depicting an application of a coating with the coating simulator of FIG. 1, according to one embodiment of the present invention.

### DESCRIPTION OF PREFERRED EMBODIMENTS OF THE INVENTION

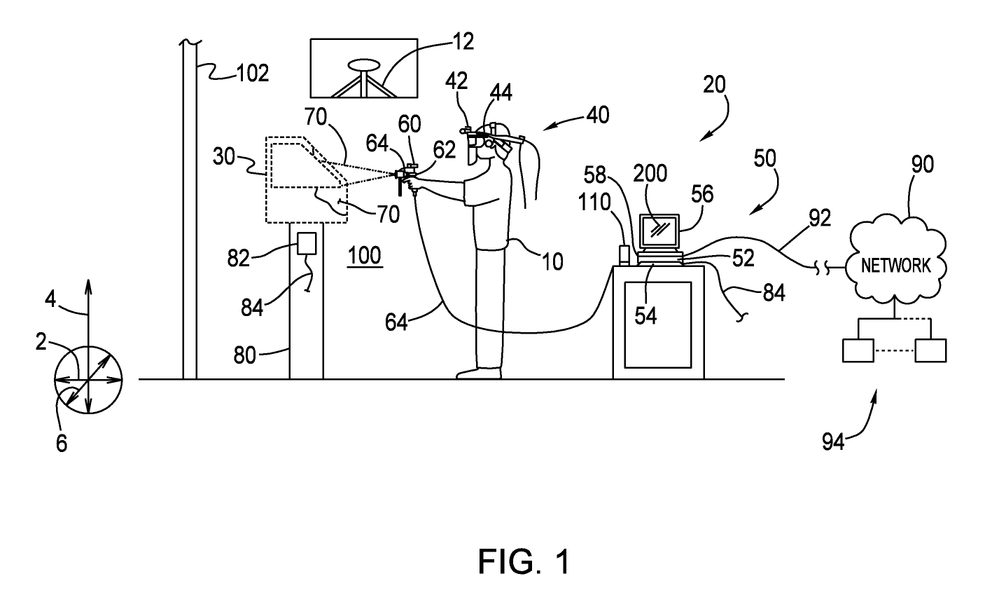

FIG. 1 depicts a person 10 operating a simulator 20 for training, e.g., developing and/or improving skills, and for evaluating the skill of the person 10 in performing a skill-oriented task or step within a process such as a task or step performed by a tradesman. In one embodiment, the simulator 20 is a coating simulator for training and evaluating performance by the person 10 of a task of applying one or more coatings to a work piece. It should be appreciated that, as described herein, the simulator 20 can be used for training, developing and improving other skills required in skill-oriented tasks performed by tradesman. It should also be appreciated that the simulator 20 may be implemented as a project based system wherein an individual instructor may define his/her own performance characteristics including those unique to the instructor and a given application, and/or which incorporate industry performance characteristics and standards.

As shown in FIG. 1, the coating simulator 20 employs augmented virtual reality to create a three-dimensional (3-D) spray coating environment 100 within a training facility 102. The 3-D spray coating environment 100 presents near real-time 3-D virtual imagery of a work piece 30 aligned with the person 10 and the coating simulator 20. As shown in FIG. 1, the work piece 30 is rendered upon a work piece platform 80. In one embodiment, the platform 80 may be adjustable in a plurality of positions, for example, within any of three (3) directions including over a x-axis 2 defined in a horizontal plane toward and/or away from the person 10, a y-axis 4 defined by a vertical plane, and a z-axis 6 defined by a plane projecting to a right-hand side of the person 10 (e.g., inwardly on FIG. 1) and a left-hand side of the person 10 (e.g., outwardly from FIG. 1). One or more video cameras 42 and other sensors 44 provided on, for example, a head-mounted display unit (HMDU) 40 worn by the person 10 provide data to a processing system 50 which reconstructs a position and orientation of a controller 60 (e.g., a spray controller) in relation to the platform 80 and the work piece 30 presented thereon. As the controller 60 is operated by the person 10, the processing system 50 generates virtual imagery of the controller 60 applying a virtual coating 70 to the work piece 30. The person 10 is able to interact with the augmented reality provided in the 3-D spray coating environment 100, for example, view and otherwise sense (e.g., see, feel and hear) the work piece 30, the controller 60 and the coating 70 as it is being applied. The interaction is monitored and data therefrom is recorded to permit performance evaluation by the person 10 and/or an instructor 12 present during training or otherwise monitoring the interaction at the training facility 102 or from another location remote from the training facility 102, as is described in further detail below.

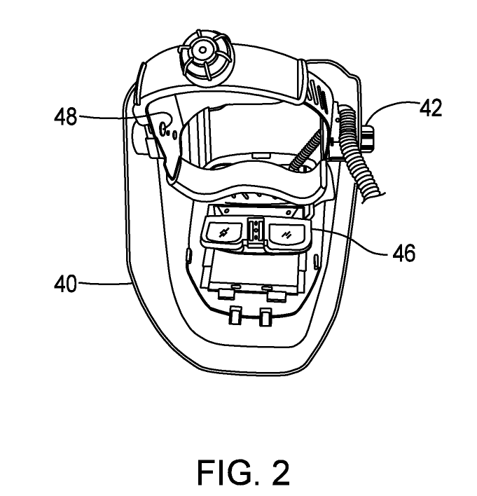

In one embodiment, the coating simulator 20 generates audio, visual and other forms of sensory output, for example, vibration, air flow, workplace disturbance, and the like, to simulate senses experienced by the person 10 as if the operation is being performed in a real world setting. For example, the coating simulator 20 simulates experiences that the person 10 may encounter when performing the coating task “in the field,” e.g., outside of the training environment. As shown in FIG. 2, the HMDU 40 includes a display device 46 and audio speakers 48 that provide images and sounds generated by the coating simulator 20 to the person 10. In keeping with the goal of accurately simulating real world settings and work experiences within the 3-D spray coating environment 100, the spray controller 60 of the coating simulator 20 emulates characteristics of an actual spray gun and the sound and feel (e.g., weight, vibration and the like) of operating the same. For example, the controller 60 is similar in configuration as a conventional spray gun model available for purchase by those in the industry, including being substantially the same in terms of shape, weight and operating features and functions. Input and output devices of the HMDU 40 and the spray controller 60 such as, for example, the cameras 42, the sensors 44, the display 46, and the speakers 48 of the HMDU 40, and sensors 62 and haptic devices 64 that impart forces, vibrations and/or motion to the person 10 (e.g., rumble packs) of the controller 60, are incorporated into the conventional form factors. Moreover, control knobs, buttons and the like, that are used to set coating parameters of the spray gun, compressor and like peripheral equipment, are simulated on the spray controller 60 and/or the data processing system 50. Signals from these input and output devices (as described below) are input signals and provide data to the processing system 50. The data is processed and provided to permit a thorough evaluation of the simulated coating procedure including the settings of equipment used therein.

As should be appreciated, the HMDU 40, the spray controller 60 and the work piece platform 80 provide a plurality of inputs to the coating simulator 20. The plurality of inputs includes, for example, spatial positioning, angular orientation and movement data and information for tracking the position of the spray controller 60 within the 3-D spray coating environment 100. The HMDU 40, the spray controller 60 and/or the work piece platform 80 may include sensors that track the movement of the person 10 operating the controller 60. In one embodiment, sensors 62 and 82 such as, for example, magnetic sensors, are mounted to and/or within the spray controller 60 and the work piece platform 80 for measuring spatial position and angular orientation within the 3-D spray coating environment 100. In one embodiment, the sensors 62 and 82 of the controller 60 and the platform 80 are components of a six degree of freedom (e.g., x, y, z for linear direction, and pitch, yaw, and roll for angular direction) tracking system 110 such as, for example, is available as a Polhemus PATRIOT™ Tracking System, model number 4A0520-01, from the Polhemus company (Colchester, Vt. USA) operatively coupled to the processing system 50. It should be appreciated that it is within the scope of the present invention to employ other tracking systems for locating the controller 60 in relation to the platform 80 and the work piece 30.

As shown in FIG. 1, the sensors 62 and 82 output data that is received by the tracking system 110 over communication connections 64 and 84 (e.g., provide input) and provided to the processing device 50 for use in determining the person's 10 and the spray controller's 60 movement within the 3-D spray coating environment 100, e.g., in relation to the work piece 30 and platform 80. While shown as wired communication connections, it should be appreciated that the communication connections 64 and 84 may be or may include wireless communication connections.

In one embodiment, the processing system 50 is a standalone or networked computing device 52 having one or more microprocessors, memory (e.g., ROM, RAM), and/or data storage devices 140 (e.g., hard drives, optical storage devices, and the like) as is known in the art. The computing device 52 includes an input device 54 such as, for example, a keyboard, mouse or like pointing device, ports 58 for receiving data such as, for example, a plug or terminal receiving the wired communication connections 64 and 84 from the sensors 62 and 82 directly or from the tracking system 110, and an output device 56 such as, for example, one or more display devices operative coupled to the computing device 52 such as a monitor coupled directly to the computing device or portable device such as a personal digital assistant (PDA), IPAD or the like. In one embodiment, the output devices 46 and 56 exhibits one or more graphical user interfaces 200 (as described below) that may be viewed by the person 10 operating the coating simulator 20 and/or the instructor 12 observing and evaluating the person's 10 performance. In one embodiment, the processing system 50 includes network communication circuitry for operatively coupling the processing system 50 by wired or wireless communication connections 92 to a network 90 such as, for example, an intranet, extranet or the Internet, and to other processing systems, display devices and/or data storage devices 94.

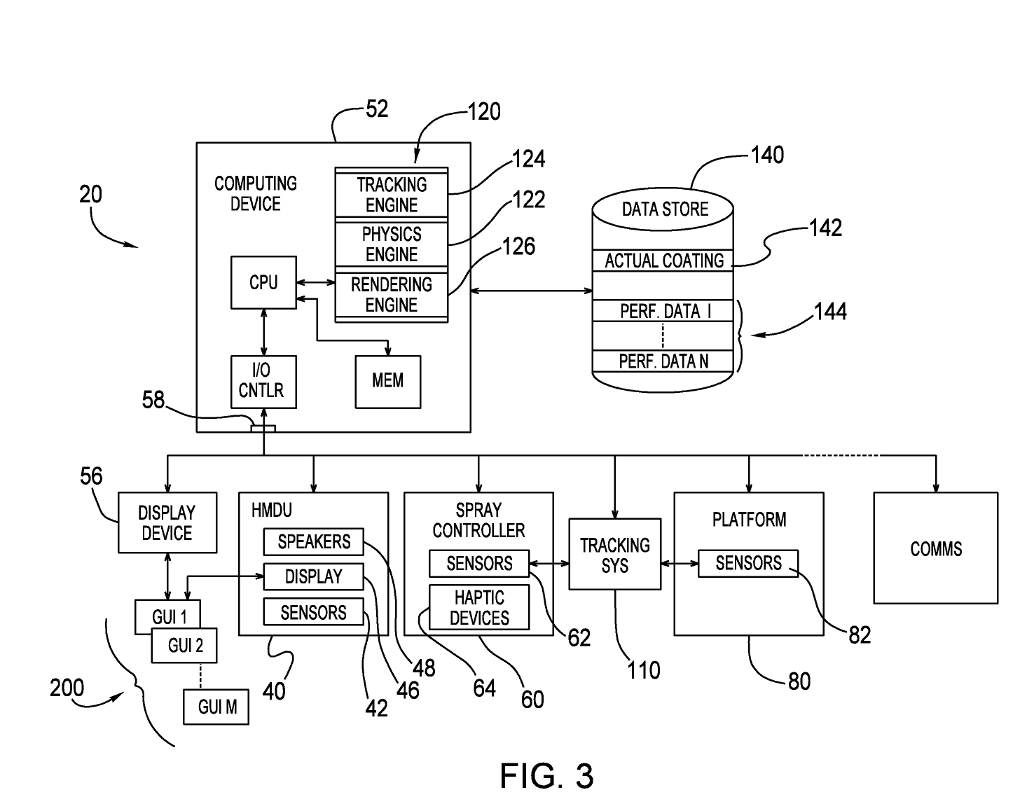

As shown in FIG. 3, a simplified block diagram view of the coating simulator 20, the computing device 52 of the processing system 50 invokes one or more algorithms 120 programmed and executing within, or hosted at a remote location and cooperating with, the computing device 52 to generate and provide the 3-D spray coating environment 100. The algorithms 120 include, for example, a physics engine 122, a tracking engine 124, and a rendering engine 126. The physics engine 122 models an actual spray coating process and outputs a virtual spray pattern (e.g., the virtual coating 70) that is rendered on the work piece 30. The tracking engine 124 receives input and data from the coating environment 100 such as a spatial position and/or an angular orientation of the spray controller 60 from the work piece 30, as well as a speed of movement of the spray controller 60 in relation to the work piece platform 80 as provided by the sensors 62 and 82. The tracking engine 124 processes the input and data and provides coordinates to the physics engine 122. The physics engine 122 models a spray coating application based on the received input, data and coordinates, to determine virtual coating spray pattern information. The physics engine 122 provides the determined virtual coating spray pattern information to the rendering engine 126 such that a virtual coating spray pattern (e.g., the virtual coating 70) is rendered in the 3-D spray coating environment 100. It should be appreciated that one or more of the algorithms 120 described herein (e.g., the physics engine 122, the tracking engine 124 and the rendering engine 126) may access a data store 140 including data describing an actual spray coating process 142, previous virtual spray patterns and performance criterion 144 for one or more trainee/operators (e.g., the person 10), and like coating simulation data as well as variables and/or parameters used by the coating simulator 20. It should be appreciated that the input and data is processed by the computing device 52 in near real-time such that the position, orientation and speed of movement of the spray controller 60 and path of the virtual spray coating 70 directed therefrom is depicted on the work piece 30 as the person 10 is performing a coating operation. That is, characteristics of the path (e.g., overspray and/or underspray, and the like) are depicted on or near the work piece 30 as if the virtual coating 70 is actually being applied by the person 10 operating the coating simulator 20.

It also should be appreciated that the data includes one or more parameters set by the person 10 on the spray controller 60 and/or entered via the display device 56 simulating coating process setting such as, for example, a compressor setting of air pressure, flow rate of the coating and other spray coating process parameters as are known in the art. In effect, the physics engine 122, tracking engine 124 and rendering engine 126 simulate coverage of the work piece 30 by a selected coating. The coating simulator 20 ensures accuracy of its simulation by depicting and selectively exhibiting one or more characteristics of the spray path including the region of coverage, whether coverage is on or off the work piece 30 and the like. In one embodiment, variations within the coverage pattern, for example, areas of below target, target and over target buildup (e.g., finish coat thickness) are depicted in one of differing colors or are identified by icons or other visual indicators on the work piece during virtual application and/or subsequent thereto such as, for example, in an evaluation mode, a specific instructional mode and/or a playback mode, where one or more coating procedures are shown to the person 10 (e.g., operator) and/or instructor 12.

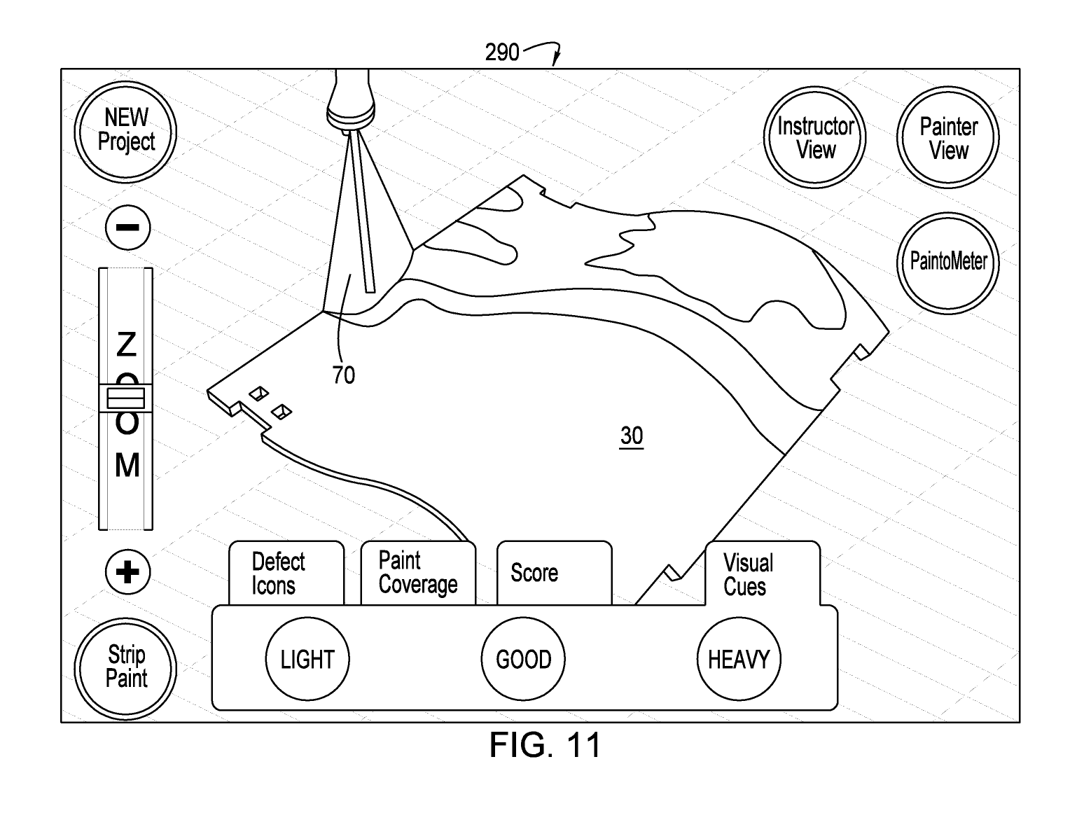

In one embodiment, the coating simulator 20 provides sensory cues (e.g., visual, audio and/or tactile cues) as teaching tools. For example, a visual cue includes a distance gauge 292 (FIG. 11) that changes color, i.e., from a first color (e.g., a red color) to a second color (e.g., a green color) as the person 10 moves the spray controller 60 from a position/distance that is too far (e.g., red color position) from the work piece 30 to a more optimal position from the work piece 30 (e.g., green color position) and from the second color either back to the first color or to a third color (e.g., a blue color) as the spray controller 60 is moved too close to the work piece 30. It should be appreciated that the distance gauge 292 is not equivalent to merely recording and outputting distance readings in a report or during the evaluation mode, which the simulator 20 may also do. Rather, the sensory cues are provided to the person 10 as he/she operates the coating simulator 20 during a coating process such that the person 10 may adjust, for example, the angle, distance, and/or speed of the spray controller 60 in relation to the work piece 30 and/or the work piece platform 80 during an on-going coating process. Moreover, while a visual display of color is described above as providing an indication of performance characteristics, it should be appreciated that other sensory cues may be used such as, for example, an audio tone (e.g., output by the speakers 48 of the HMDU 40) that may increase in volume or a repeated pattern as the controller 60 is positioned too close to the work piece 30 and/or decrease in volume or repeated pattern as the controller 60 is position too far from the work piece 30.

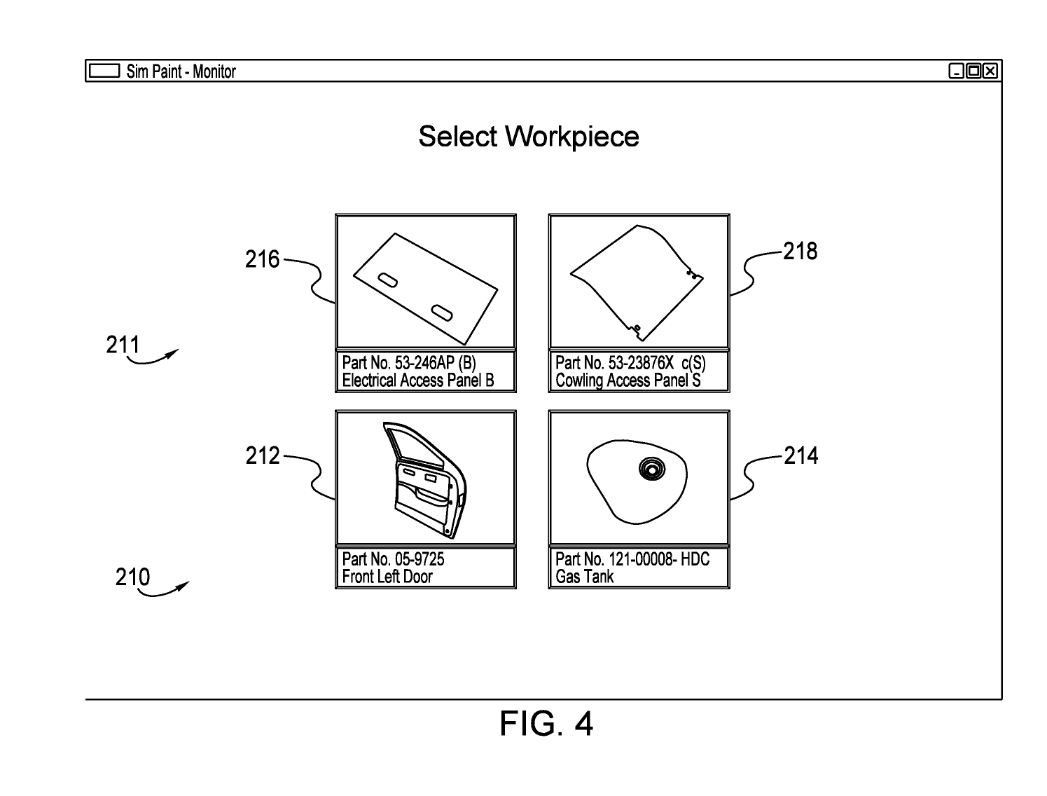

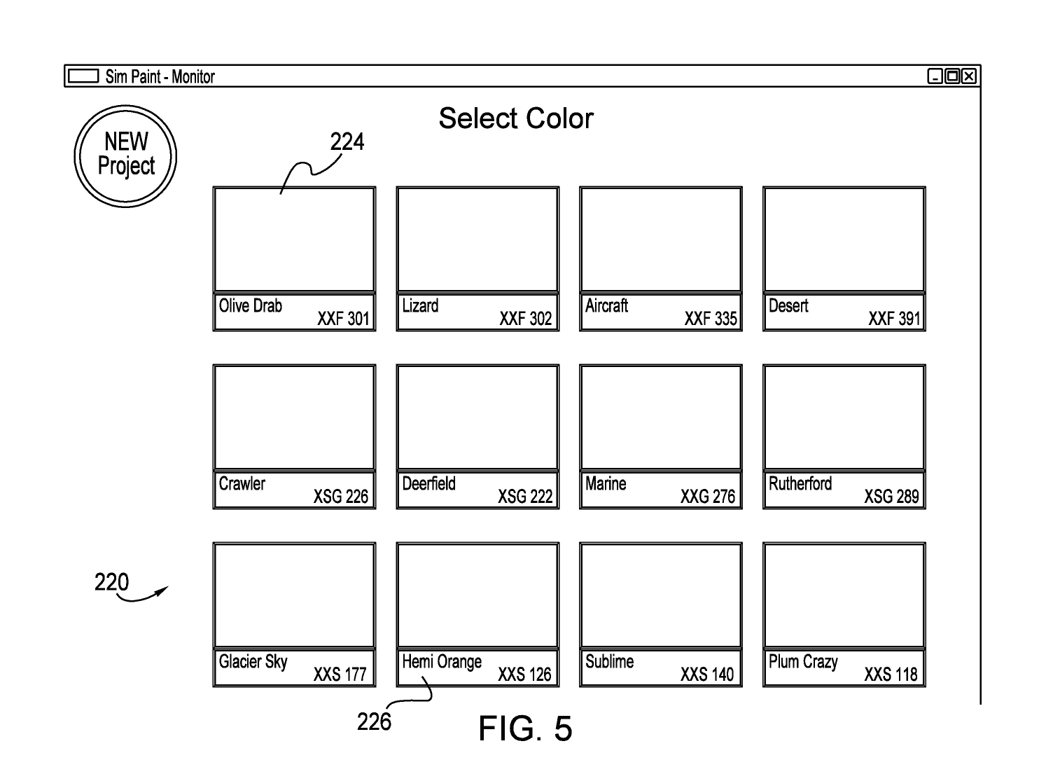

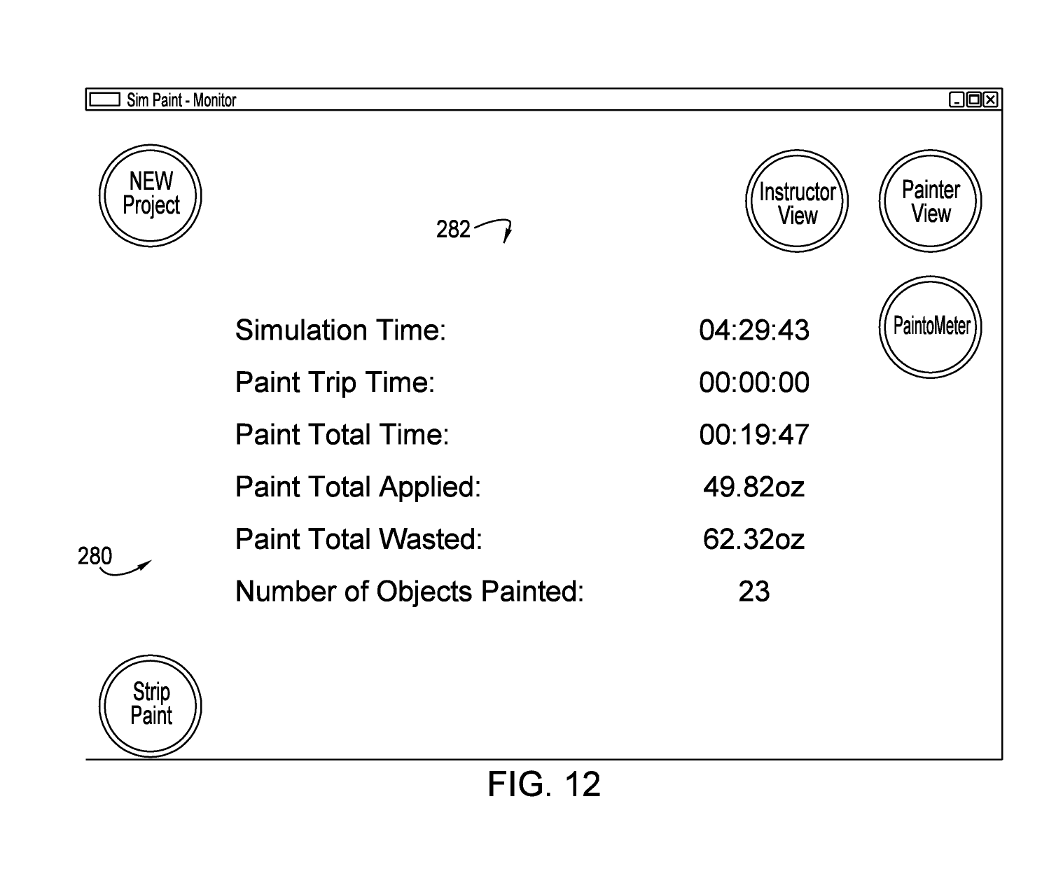

FIGS. 4-12 depict a plurality of graphical user interfaces (GUI) 200 of the coating simulator 20 that may be presented on one or both of the display device 56 coupled to the computing device 52 and/or the display 46 of the HMDU 40. In FIG. 4, a GUI 210 prompts an operator (e.g., the person 10) to initiate the training session by selecting a work piece from a plurality of predefined work pieces 211. For example, GUI 210 presents a door 212, a gas tank 214, an electrical access panel 216 and a cowling access panel 218 as work pieces from the plurality of predefined work pieces 211 modeled by the coating simulator 20. In one embodiment, models of other work pieces may be imported into the coating simulator 20 such that specific materials, configurations (e.g., parts) of interest, for example, to a particular company are available for training and practice procedures. As shown in FIG. 5, a GUI 220 prompts the operator to select certain coating set-up parameters such as a finish type, finish coating color 224, 226, target thickness (e.g., a 1 mil to 20 mil.), and surface/material type. In one embodiment, the simulator 20 incorporates a large variety of colors and types of coatings as well as sheens and/or textures (e.g., flat, semi-gloss, and the like). While not shown, it should be appreciated that one or more additional ones of the GUIs 200 prompt the operator to select settings for equipment used in the coating application, for example, setting of the spray gun controller 60 and/or a compressor and the like. For example, the operator selects settings such as, for example, spray gun type, fan size, air pressure and flow rate. The selected settings are provide to and recorded by the data processing system 50 such that the operator's choice or selection may be captured and evaluated within an evaluation of his/her overall performance of a particular coating procedures, for example, from setup, startup of equipment, through use of equipment in application of a coating, to completion and shutdown of equipment, and cleanup.

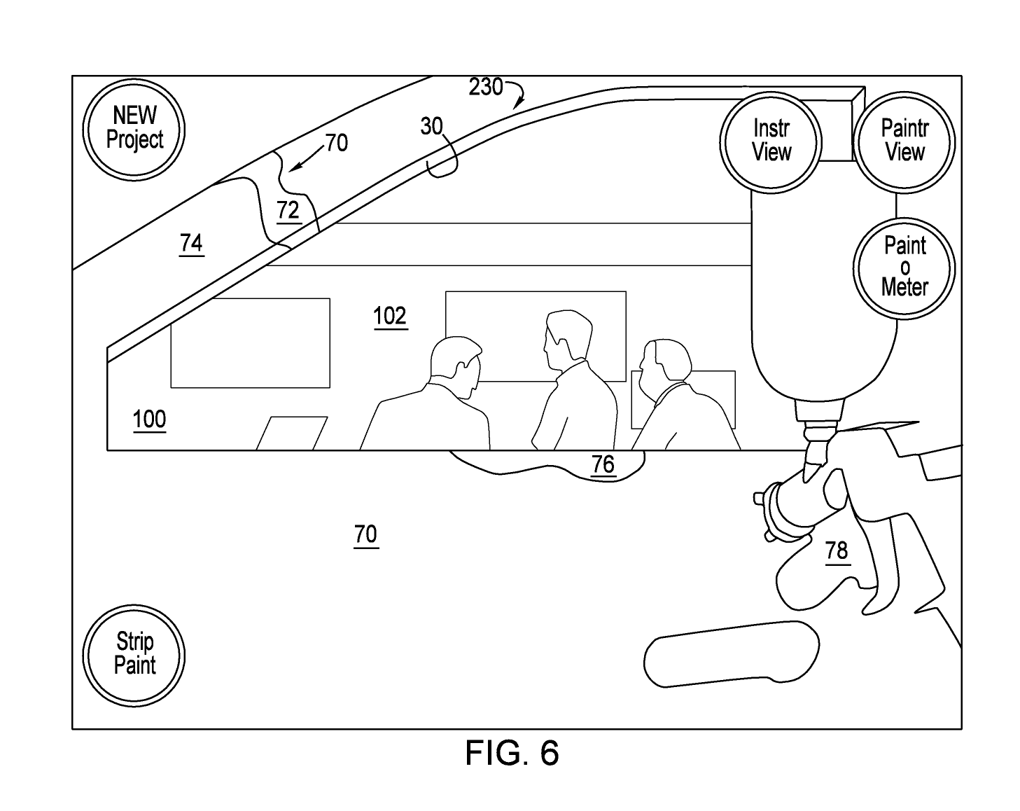

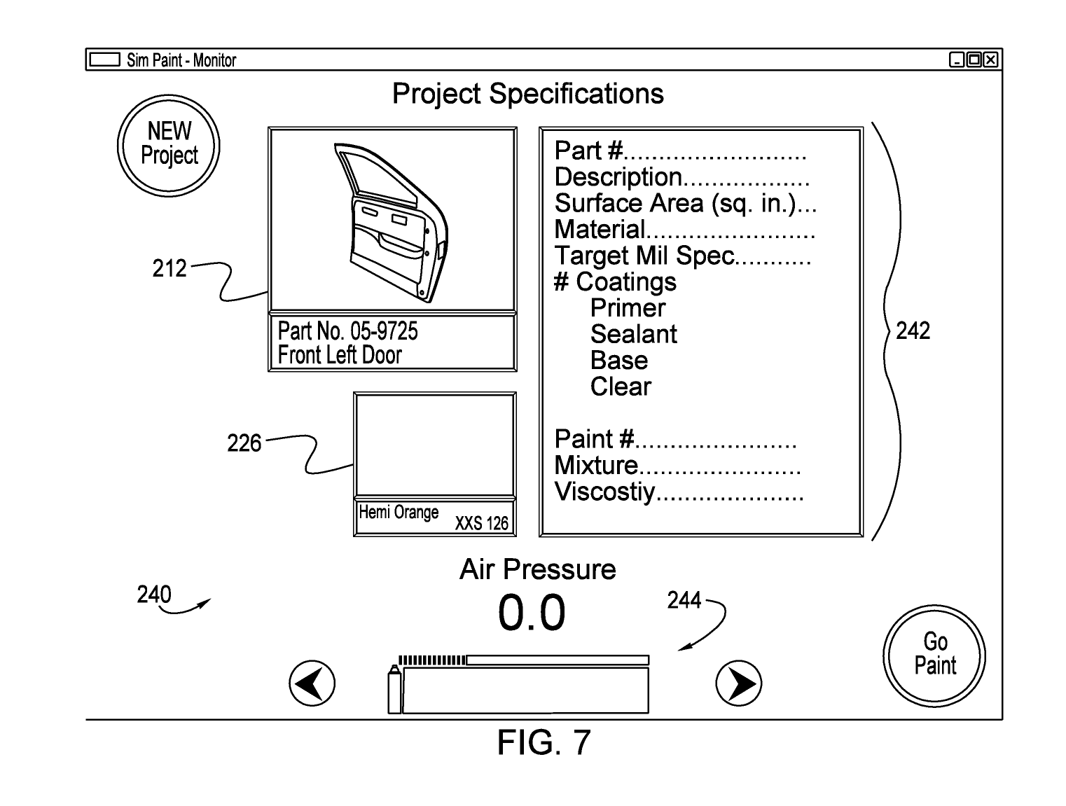

FIG. 6 depicts the 3-D spray coating environment 100 on a GUI 230. For example, the GUI 230 depicts a rendering of the work piece 30 in a real-world setting 102. As shown in FIG. 6, the controller 60 is rendered and depicts application of the virtual coating 70 on the work piece 30, e.g., a door. The door 30 has been virtually painted using the finish coating color 226 selected on the GUI 220 (FIG. 5). It should be appreciated one or more regions of coverage 72, 74, 76 and 78 are depicted in the GUI 230 representing one or more thicknesses or accumulation of the coating 70. In FIG. 7, a GUI 240 presents a coating project specification summary 242 to the operator and/or a trainer/teacher/evaluator/instructor. As shown in FIG. 7, the summary 242 highlights the operators choice of a part (e.g., part 212) and one or more coating (e.g., a coating 226) to be applied to the part during a spray coating application procedure using the coating simulator 20. The summary 242 further documents parameters set by the operator 10 such as, for example, air pressure 244, provided by a compressor to the controller 60.

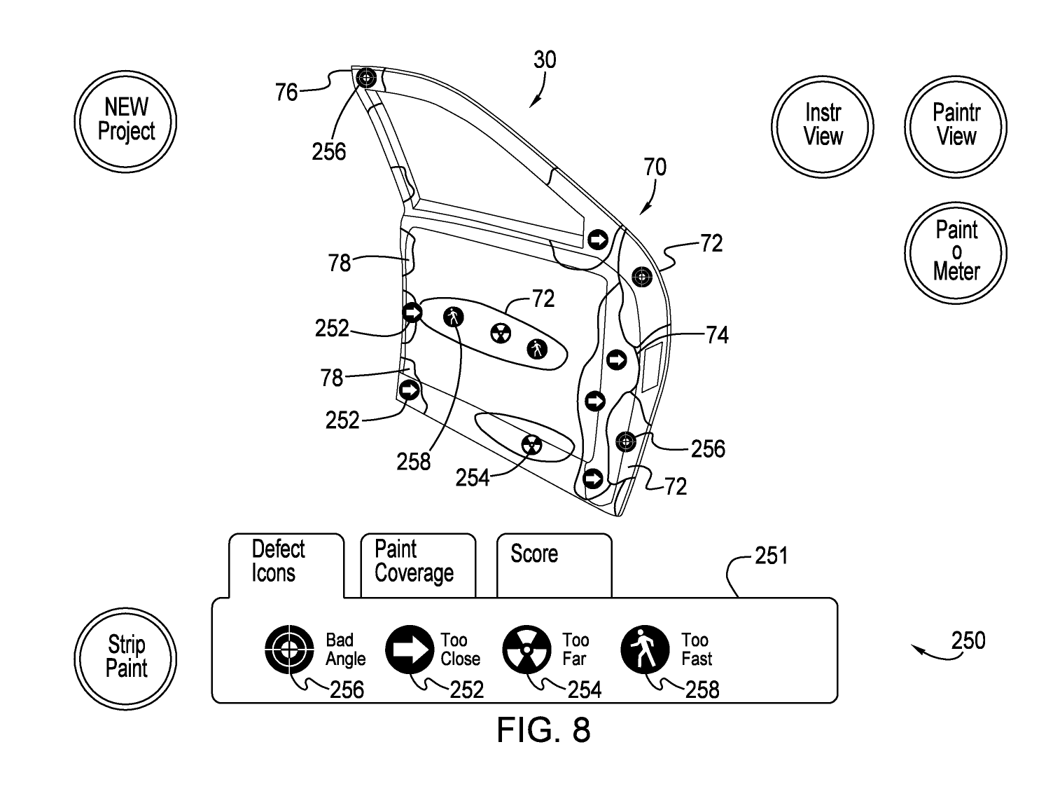

As shown in FIGS. 8-11, GUIs 250, 260, 270 and 280, respectively, depict one or more performance, evaluation and instructional views provided by the simulator 20 of a spray coating application procedure. For example, as shown in FIG. 8, the GUI 250 depicts the work piece 30 (e.g., the door 212), the virtual coating 70 applied to the work piece 30 and the coverage regions 72, 74, 76 and 78 as well as real-time sensory instruction and/or guidance, for example, icons 252, 254, 256, 258 that highlight various characteristics of the application procedure. For example, and as illustrated by legend 251, icons may include a “Too Close” indication 252 (e.g., a sensory indication that the spray controller 60 was held too close to the work piece 30 during a portion of the application procedure), a “Too Far” indication 254 (e.g., a sensory indication that the spray controller 60 was held too far from the work piece 30 during a portion of the application procedure), a “Bad Angle” indication 256 (e.g., a sensory indication that the spray controller 60 was held at an angle that is less than optimal for application of the subject coating), and a “Too Fast” indication 258 (e.g., a sensory indication that the spray controller 60 was moved too quickly across the portion of the work piece 30 such that less than optimal coverage was achieved).

As should be appreciated, it is within the scope of the present invention to provide more and/or different sensory indications (e.g., audio and/or tactile indications) to illustrate, for example, both favorable and/or unfavorable aspects of the virtual coating application process being performed. It should also be appreciated that the sensory indications (e.g., the icons 252, 254, 256, 258 and other indications) are presented as the application procedure is being performed, for example, as the virtual coating 70 is being applied to the work piece 30 such that the operator 10 receives real-time feedback on his/her performance. The inventors have discovered that this in-process, real-time sensory guidance (e.g., the visual, audio and/or tactile indications) can improve training of the operator 10 by influencing and/or encouraging in-process changes by the operator 10 such as positioning (e.g., proximity and/or angle) of the controller 60 in relation to the work piece 30. As can be appreciated, repeated performance at, or within a predetermined range of, optimal performance characteristics develops and/or reinforces skills necessary for performing a skill-oriented task. Accordingly, the simulator 20 and its real-time evaluation and sensory guidance toward optimal performance characteristics are seen as advantages over conventional training techniques.

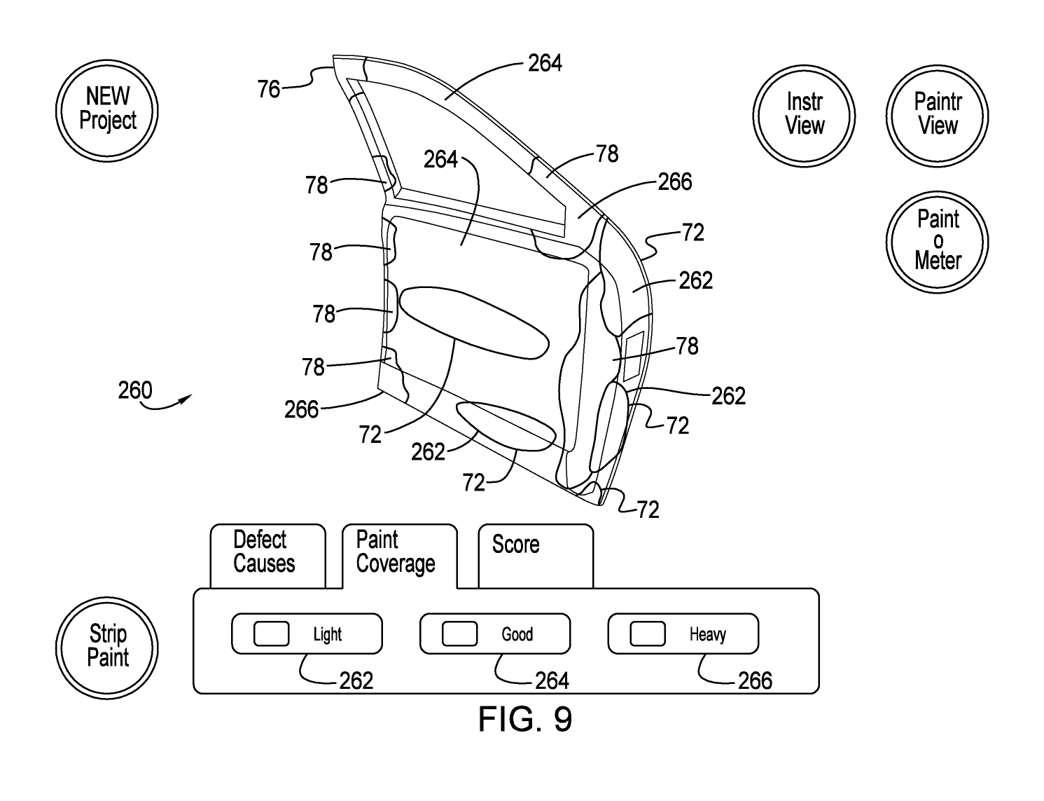

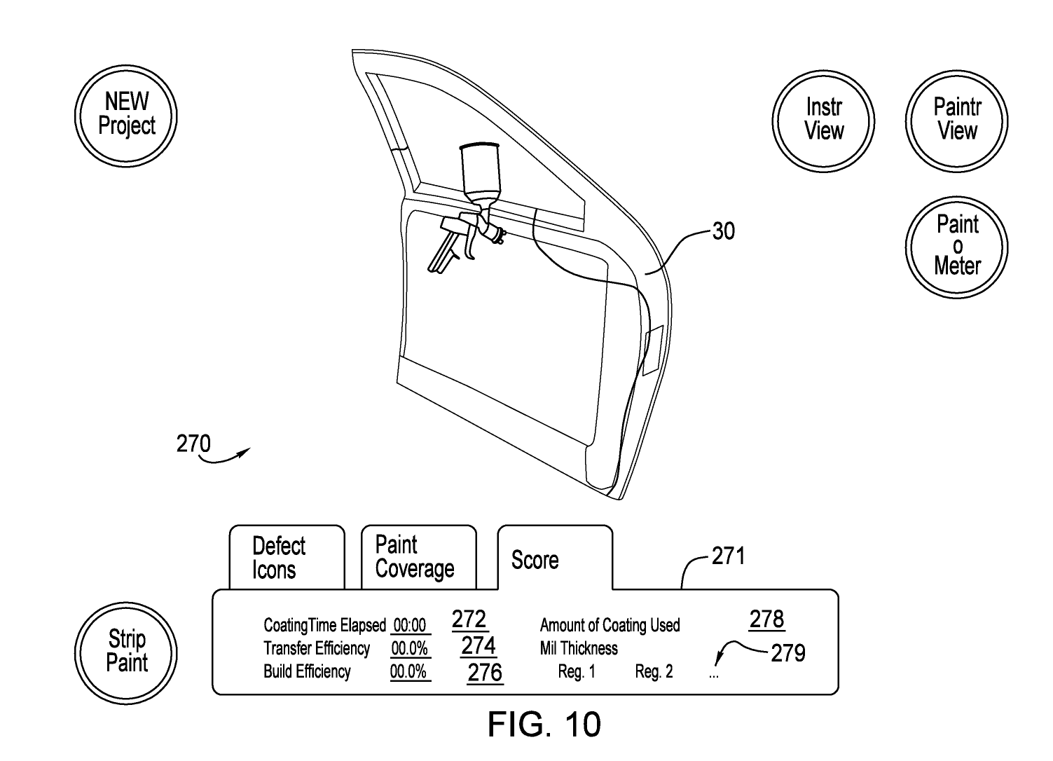

In FIG. 9, the GUI 260 depicts the coverage regions 72, 74, 76, and 78 and their boundaries by visually indicating a color coding scheme. The color code scheme, as indicated in legend 261, highlights areas/regions where the coating was applied in a particular manner, e.g., “light” 262, “good” 264, and “heavy” 266. In FIG. 10, the GUI 270 presents performance data to the operator 10 and/or instructor 12. The performance data collected and presented at legend 271 includes, for example, total coating time 272, transfer efficiency 274, build efficiency 276, amount of coating used 278 and approximate mil thickness 279 thus providing the operator 10 and/or instructor 12 with feedback as to the operator's performance. In one embodiment, the depiction of the work piece 30 may illustrate one or more of the performance parameters with color, shading, icons or the like. Additionally, the GUI 270 may selectively compare the performance of a current session/application procedure to one or more previous sessions to measure a positive or a negative trend in performance at or toward optimal and/or satisfactory ranges. In FIG. 11, the GUI 280 provides summary information 282 that highlights performance characteristics as well as factors that may be used in, for example, a return on investment (ROI) determination demonstrating cost benefits achieved by using the inventive simulator 20 for skill-oriented training. In one embodiment, one of more of the GUIs 250, 260 and 270 may include features and functions for the instructor 12 to highlight and discuss one or more of the performance measurements on the work piece 30 during or after a session/application procedure to even further facilitate learning.

Some perceived benefits of the simulator 20 include, for example:

1. Innovation—provide a boost to training programs by utilizing a state-of-the-art tool.
a. Breakthrough virtual and augmented reality technology are used to simulate real spraying coating processes.
b. Real spray gun and peripheral equipment provide the look and feel of spray coating operations.
c. No spray booth is required
d. The simulator and training equipment is portable for easy setup in any classroom environment.
e. The simulator and training equipment is cost effective.
   2. Education—Increase valuable hands-on training.
a. Instructors:

(1) Set the specific part, paint and coating requirements.

(2) Immediately evaluate the spray gun's position, distance, and speed to pinpoint errors in technique.

(3) Rotate and inspect the virtual work-piece for paint coverage and consistency.

(4) See savings and return on investment figures in a Paintometer™ graphical user interface.
b. Students:

(1) Toggle real time motion tracking cues to learn proper spray painting techniques.

(2) Discover what techniques can produce defects.

(3) Learn in a safe environment without potentially hazardous fumes and chemicals.

(4) Practice more, in less time as set-up and clean-up is substantially minimized.

3. Conservation—Reduce the carbon footprint of the training.
a. Environmentally friendly:

(1) Minimize over spray.

(2) Decrease need for rework.

(3) Limit release of hazardous volatile organic compounds (VOCs).
b. Save Cost of:

(1) Materials—parts, paint, thinner, air filters, and cleaning supplies.

(2) Energy consumption.

(3) Hazardous material disposal fees.

While the invention has been described with reference to various exemplary embodiments, it will be understood by those skilled in the art that various changes may be made and equivalents may be substituted for elements thereof without departing from the scope of the invention. For example, while described above as a spray coating simulator that simulates application of a coating to a work piece, in other applications the features and functions of the simulator may be implemented to train operators in, for example, any skill-oriented task such as ablation processes, sandblasting and other removal processes, welding, plumbing and other operations performed by skilled tradesmen. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A simulator for skill-oriented training of a task, the simulator comprising:
a work piece platform having at least one platform sensor;
an augmented, three-dimensional training environment, the training environment depicting a work piece rendered on the work piece platform;
a head-mounted display unit (HMDU) worn by a person operating the simulator, the HMDU having at least one camera, at least one speaker and at least one HMDU sensor, the at least one camera and the at least one speaker providing visual and audio output to the person depicting the training environment;
a controller operated by the person, the controller having at least one controller sensor, the at least one controller sensor, the at least one HMDU sensor and the at least one platform sensor cooperating to output one or more signals representing spatial positioning, angular orientation and movement data of the controller relative to the work piece platform;
a data processing system coupled to the work piece platform, the HMDU, and the controller, the data processing system receiving the one or more signals and executing a plurality of algorithms for rendering in real-time the work piece, a virtual coating spray pattern, a virtual coating as applied to the work piece and sensory guidance as to performance to the person in the training environment, the algorithms including:
a tracking engine that receives the one or more signals from the at least one controller sensor, the at least one HMDU sensor and the at least one platform sensor, the tracking engine determines coordinates of a next position, next orientation, and a speed of movement of the controller in relation to the work piece and the work piece platform from a previous position and a previous orientation to the next position and the next orientation;
a physics engine coupled to the tracking engine, the physics engine models a spray coating process and determines the virtual coating spray pattern and the applied virtual coating from the coordinates within the training environment; and
a rendering engine coupled to the physics engine, the rendering engine receives the modeled spray coat process and, in response thereto, renders the virtual coating spray pattern and the applied virtual coating in the training environment;
the virtual coating spray pattern, the applied virtual coating and the sensory guidance are exhibited in near real-time to the operator within the training environment to provide in-process correction and reinforcement of preferred performance characteristics as the operator operates the controller.

2. The simulator of claim 1, wherein the sensory guidance exhibited to the operator include one or more of visual, audio and tactile indications of performance.

3. The simulator of claim 2, wherein the applied virtual coating is depicted to include a plurality of coverage regions and the visual indications include one or more icons highlighting one or more of the plurality of coverage regions having less than optimal characteristics.

4. The simulator of claim 3, wherein the one or more icons include a Too Close indication icon, a Too Far indication icon, a Bad Angle indication icon and a Too Fast indication icon.

5. The simulator of claim 2, wherein the audio indications of performance include an audio tone output by the at least one speaker of the HMDU.

6. The simulator of claim 5, wherein the audio tone at least one of increases in volume or repeated pattern as the controller is positioned too close to the work piece, and decreases in volume or repeated pattern as the controller is position too far from the work piece.

7. The simulator of claim 1, a display device operatively coupled to the data processing system such that an instructor may monitor the performance of the person operating the controller.

8. The simulator of claim 1, wherein the controller further includes one or more haptic devices that impart at least one of forces, vibrations and motion to the person operating the controller.
